(19) United States
(12) Patent Application Publication
(10) Pub. No.: US 2023/0257556 A1
(43) Pub. Date: Aug. 17, 2023

(54) ENCAPSULATED ANTISTATIC AGENT COMPOSITION AND A METHOD FOR PREPARATION THEREOF

(71) Applicant: AVIENT SWITZERLAND GMBH, Muttenz (CH)

(72) Inventors: Subramanian KALIAPPAN, Thane (W) (IN); Nagesh Appasaheb WAGDARE, Navi Mumbai (IN); Antonello DECORTES, Milan (IT); Wolfgang Ulrich SOHLING, Freising (DE); Rossella FARRIS, Milano (IT); Jayavant Ratan SHIRKE, Maharashtra (IN); Rahul Kishore HEDAOO, Kalyan (W) (IN)

(73) Assignee: AVIENT SWITZERLAND GMBH, Muttenz (CH)

(21) Appl. No.: 17/767,536

(22) PCT Filed: Oct. 8, 2020
(86) PCT No.: PCT/EP2020/078243

§ 371 Date: Apr. 8, 2022

(30) Foreign Application Priority Data
Oct. 11, 2019 (IN) 201911041180

(51) Int. Cl. C08K 9/10; C08J 3/22; C08K 3/36; C08K 3/34; C08K 5/103

(52) U.S. Cl. CPC C08K 9/10; C08J 3/226; C08K 3/36; C08K 3/346; C08K 5/103; C08K 2201/005; C08K 2201/017

(57) ABSTRACT

The present invention relates to an encapsulated antistatic agent composition and a method for preparation thereof. The encapsulated antistatic agent composition of the present disclosure provides long lasting antistatic action in plastic products and is used in masterbatch. The encapsulated antistatic agent composition comprises a carrier consisting of a mixture of silica and clay, and an antistatic agent encapsulated in the carrier.

### FIELD OF THE INVENTION

The present invention relates to the encapsulated antistatic agent composition. More particularly, the present invention relates to encapsulated antistatic agent composition wherein the antistatic agent is encapsulated in a carrier consisting of a mixture of silica and clay. Moreover, it relates to the production of the masterbatch (MB) which contains encapsulated antistatic agent which is incorporated into the polymer matrix of MB to overcome the static problems of plastic products. This invention makes an effort to overcome the drawbacks of the previously known antistatic agents.

### BACKGROUND OF THE INVENTION

Nowadays, plastics have replaced metals and become the material of choice because they have higher flexibility, lighter weight, better colorability and higher cost effectiveness (Harper C. A (1999), Amarasekera J (2005)). However, static problems are mainly associated with plastics products having challenges in processing and transforming industry, there is adverse effect on the performance during usage.

The antistatic agents are often incorporated in plastic product to overcome such problems. The function of antistatic agent is to prevent the build-up of static electrical charge due to the transfer of electrons to the material surface. Antistatic agents reduce the tendency of surfaces to accumulate electrostatic charges (S. R. Hartshorn, S. S. Thind, in Comprehensive Heterocyclic Chemistry, 1984).

Nonionic-type antistatic agent finds the widest use because of their low cost and minimal effect on the mechanical properties of the plastic. Ease of use is another favourable aspect to nonionics. They can be mixed with the bulk of the plastic prior to processing in a masterbatch form or can be applied as coating to the surface of the finished plastic article as the need dictates. However, the use of said nonionics do exhibit temporary effect for short duration of time. Therefore, to overcome the aforesaid drawback & extend anti-static impact for long term, encapsulation technology would be favourable solution.

The antistatic agents can be divided into ionic, amphoteric, and nonionic points. Ionic antistatic agents include cationic compounds, such as quaternary ammonium, phosphonium, or sulfonium salts, and anionic compounds, usually sodium salts of sulfonates, phosphates, and carboxylic acids. Nonionic antistatic agents include esters, such as glycerol esters of fatty acids, ethoxylated tertiary amines, ethoxylated amides and alkylsulfonate esters. Many are FDA- or EU approved. Nonionic antistatics are commonly used in polyolefins; glyceryl monostearate is used in many polypropylene injection molding applications, at levels ranging from 0.05 to >1%. Loading levels depend on resin processing temperatures, the presence of other additives, and application requirements such as clarity, printability, and FDA compliance (Clive Maier, Teresa Calafut, in Polypropylene, 1998). They may be incorporated with the other ingredients during the compounding stage or applied directly to the surface as an antistatic coating.

However, after incorporation most of the antistatic agent has the tendency to come up on the surface, gets washed off and hence there is non-availability of these antistatic agent. Therefore, the antistatic effect is retained only for short duration of time.

CN 103709493 discloses a polymer composition whereas the polymer is a combination of three different low-density polyethylene (LDPE) polymers; the MB comprises an additional inorganic material. The above-mentioned ingredients are put into a high-speed blender to be fully and uniformly melted after high-speed blending, thereafter discharged, cooled, fully cured, and then crashed and sieved to obtain a finished product. The master batch and the preparation method disclosed by the invention can be applied to modification of plastic products in plastic processing industry.

CN 104250403 discloses a composition whereas the MB comprises besides the polyethylene (PE)/polypropylene (PP) carrier and the antistatic agent, an anti-blocking agent (preferably silica as release agent, but only 0.1-1 parts), an anti-oxidant and one or more compound stabilizers. The masterbatch antistatic has good antistatic effect, lasting effect and good dustproof effect.

CN 106633392 discloses a composition whereas the MB comprises a polypropylene (PP) carrier resin, polyamide (PA) resin particles, 10 to 15 parts of active aluminium oxide powder, 10-15% clay and additionally MgCl₂, dispersant and a coupling agent. The functional master batch has the advantages that the PA resin particles, the active aluminum oxide powder, the clay and the magnesium chloride are compounded, so that a polypropylene product achieves the effects that the wetness degree of the polypropylene product is improved by combining water through a chemical or physical path, and meanwhile, the excess charge generated in the polypropylene product is timely dispersed, so that the antistatic capability of a polypropylene material is improved.

CN 107556579 discloses a composition whereas the MB comprises 14-20% polyethylene (PE) polymer, 80-90% bentonite and further carbon black, PE wax, phosphate coupling agent and 3-5% stearic acid amide. According to the polyethylene antistatic filling master batch disclosed by the invention, tetradecyl pyridinium bromide modified bentonite is adopted, and the compatibility between the modified bentonite and the polyethylene is improved, so that the prepared filling masterbatch is easily dispersed in the polyethylene, and the mechanical property and the antistatic property of the polyethylene are improved.

JP 2000313875 discloses that the antistatic is a (A) diethanolamide of a C10-C14 fatty acid and (C) a monoglyceride C10-C14 fatty acid; carrier resin (B) is a petal like calcium silicate powder; AB and B/C are mixed together.

As can be seen in the prior arts, encapsulation of anti-static in a carrier consisting of a mixture of silica and clay is unknown. The prior art focused on usage of antistatic agent as such and in the modification of structure of antistatic agents for improving its action. Long lasting antistatic do exist. However the usage of long lasting antistatic become a concern in terms of health and safety perspective and are quite expensive. Therefore, there exists a need to provide a cost effective antistatic agent, using temporary antistatic agents, which can show a controlled release antistatic activity. This can be achieved by encapsulating the temporary antistatic agent.

### OBJECTIVES OF THE INVENTION

The main objective of the present invention is to provide encapsulated antistatic agent composition.

Another objective of the present invention is to provide encapsulated antistatic agent composition which has higher loading amount of antistatic agent to 10 to 60%, preferably 25 to 55% and most preferably 30 to 50% due to the absorption capacity of the carriers.

Still another objective of the present invention is to provide encapsulated antistatic agent composition in which carrier of silica and clay mixture act as a barrier to the antistatic agent which leads to the slow release of antistatic agent to the surface, to achieve a prolonged antistatic effect.

Yet another objective of the present invention is to provide masterbatch (MB) which contains encapsulated antistatic agent which is well incorporated into the polymer matrix of MB.

Yet another objective of the present invention is to provide articles like films, sheets, extruded or injection moulded articles which contains encapsulated antistatic agent.

### SUMMARY OF THE INVENTION

In an aspect, the present invention provides an encapsulated antistatic agent composition comprising:

a) carrier consisting of a mixture of silica and clay; and

b) at least one antistatic agent encapsulated in the carrier

wherein the concentration of carrier is in the range of 40-90%, preferably 45-75%, most preferably 50-70% and antistatic agent is 10-60%, preferably 25-55% and most preferably 30-50% based on the total weight of the composition.

In another aspect of the present invention, antistatic agent is a glycerol ester or ethoxylated amine or ethoxylated amide or alkyl sulfonate esters. Glycerol ester is a glycerol monostearate. Glycerol stearate is a mixture of Stearic acid, Palmitic acid monoester with triglycerol (i.e Atmer 129) or a blend of stearic acid, monoester with triglycerol and 2,3-dihydroxypropyl laurate (i.e Grinsted PGE 308). a ethoxylated amine is a N,N-Bis(2-hydroxyethyl)-C₁₂₋₁₈-alkylamine.

In another aspect of the present invention, the carrier has concentration of clay as 50-90%, preferably 60-90% and most preferably 75-85% based on the total weight of the composition.

In yet another aspect of the present invention, the carrier has a ratio of silica to clay from 1:10 to 10:1, preferably 1:5 to 5:1, most preferably 1:3 to 3:1.

In one another aspect of the present invention, clay is selected from the group consisting of natural clays comprising bentonite, montmorillonite, beidellite, saponite, hectorite, stevensite, kerolite-saponite, kerolite, talc, pyrophyllite, attapulgite, sepiolite; a mixture of natural silica with a bentonite; any modified clays; and any mixtures thereof.

In further aspect of the present invention, the clay contains a natural or sodium activated bentonite or a mixture containing both.

In yet another aspect of the present invention, clay contains a natural or sodium activated bentonite with a cation exchange capacity in the range of 10 meq/100 g to 140 meq/100 g.

In another aspect of the present invention, the clay contains a natural or sodium activated bentonite with a cation exchange capacity in the range of 20 and 130 meq/100 g, preferably in the range of 30 and 120 meq/100 g.

In one another aspect of the present invention, clay has a surface area of more than 120 m²/g, a total pore volume of more than 0.35 ml/g and a silicon content, calculated as SiO₂, of at least 60 wt %.

In yet another aspect of the present invention, clay has more than 10% of amorphous material as determined by quantitative X-ray diffraction analysis of the mineral phases of the clay material.

In further aspect of the present invention, the silica is a precipitated silica.

In yet another aspect of the present invention, the precipitated silica is a hydrophilic precipitated silica or a hydrophobic precipitated silica or a mixture of both.

In an aspect of the present invention, the hydrophilic silica has a liquid carrying capacity determined as DOA absorption number of at least 120 ml/100 g, preferably at least 140 ml/100 g, mostly preferred at least 160 ml/100 g precipitated silica.

In another aspect of the present invention, the hydrophilic silica has a particle size d50 determined by laser diffraction of 4 to 300 μm, preferably 5 to 150 μm, mostly preferred 5 to 70 μm.

In yet another aspect of the present invention, the hydrophobic silica has a particle size d50 determined by laser diffraction of 2 to 50 μm, preferably 4 to 25 μm, mostly preferred 5 to 15 μm.

In one another aspect of the present invention, silica is used in the amount of 15% to 90%, preferably 25% to 85%, most preferably 35% to 75% based on the total weight of the composition.

In yet another aspect of the present invention, the encapsulated antistatic agent composition is used for producing masterbatch.

In another aspect of the present invention, it provides a method for preparing masterbatch of an encapsulated antistatic agent composition wherein the encapsulated antistatic agent are expediently provided in the form of a masterbatch, in which the polymer is preferably polyolefins in which the respective encapsulated antistatic is to be incorporated.

In one other aspect of the present invention, the produced masterbatch can be further converted into articles.

In yet other aspect of the present invention, articles can be films, sheets, extruded or injection moulded articles.

In further aspect of the present invention, encapsulated antistatic agent is retained at a heating cycle of a temperature in range of 100° C.-250° C. during processing of an article.

### BRIEF DESCRIPTION OF THE ACCOMPANYING DRAWING

FIG. 1 represent TGA of Encapsulated antistatic samples and Grinsted PGE 308

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition.

Thus, before describing the present invention in detail, it is to be understood that this invention is not limited to particularly exemplified process parameters that may of course, vary. It is also to be understood that the terminology used herein is for the purpose of describing particular embodiments of the invention only and is not intended to limit the scope of the invention in any manner.

Unless otherwise defined, all technical and scientific terms used herein have the same meaning as commonly understood by one of ordinary skill in the art to which this invention pertains.

Weight percentages (wt % or % wt) herein are calculated based upon total weight of the composition, unless otherwise indicated.

It must be noted that, as used in this specification and the appended claims, the singular forms “a,” “an” and “the” include plural referents unless the content clearly dictates otherwise.

The terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “comprising” “including,” “having,” “containing,” “involving,” and the like are to be understood to be open-ended, i.e., to mean including but not limited to.

In an embodiment of the present invention, there is provided an antistatic agent composition comprising:

a) carrier consisting of a mixture of silica and clay; and

b) at least one antistatic agent encapsulated in the carrier

wherein the concentration of carrier is in the range of 40-90%, preferably 45-75%, most preferably 50-70% and antistatic agent is 10-60%, preferably 25-55%, most preferably 30-50% based on the total weight of the composition.

Masterbatch compositions may comprise at least one encapsulated antistatic agent as an additive, wherein the additive present in the masterbatch has higher concentration than in the final article or final application. The concentration of encapsulated antistatic agent in the masterbatch range preferably from 2 to 20% by weight, more preferably from 5 to 15% by weight, the % weight based in each case on total weight of the masterbatch.

In another embodiment, the antistatic agent is a glycerol ester or ethoxylated amine or ethoxylated amide or alkyl sulfonate esters. The glycerol ester is a glycerol monostearate. The antistatic agent is a mixture of Stearic acid, Palmitic acid monoester with triglycerol (i.e Atmer 129) or a blend of stearic acid, monoester with triglycerol and 2,3-dihydroxypropyl laurate (i.e Grinsted PGE 308). The ethoxylated amine is a N,N-Bis(2-hydroxyethyl)-C₁₂₋₁₈-alkylamine used as an antistatic agent.

Atmer 129 is typically mixture of Stearic acid, Palmitic acid monoester with triglycerol Mostly non-ionic surfactants are used for achieving anti-static impact. Dosing of active plays a significant role for bringing desirable anti-static effect. However, the effect is still limited and not permanent.

Grinsted PGE 308 is a poly glycerol ester (blend of stearic acid, monoester with tri glycerol and 2,3-dihydroxypropyl laurate) that acts as an antistatic agent and exhibits excellent heat stability. It is completely free of amine and amide chemistry which eliminates the risk of corrosive effects on stress cracking of polycarbonate in the final applications. It is compatible with polystyrene, polyamide, LDPE, LLDPE and HDPE and can be used in PE film, PE foam, electronic packaging and injection molding applications.

In one another embodiment, the silica is selected from a group of precipitated silica.

In an embodiment, the precipitated silica is hydrophilic precipitated silica, hydrophobic precipitated silica or a mixture of both. Precipitated silica is typically produced by a precipitation of a sodium silicate with a mineral acid under neutral or slightly alkaline conditions. For the final application the filter cake of precipitated silica is dried and ground.

In an embodiment, the silica is hydrophilic precipitated silica.

The hydrophilic silica only consists of SiO₂ and does not exhibit any surface modification and is wettable by water.

In a preferred embodiment of the present invention, the hydrophilic silica has a particle size d50 determined by laser diffraction of at least 4 to 300 μm, preferably at least 5 to 150 μm, mostly preferred at least 5 to 70 μm.

The precipitated silica is selected from the group consisting of Sipernat® 22; Sipernat® 22LS, Sipernat® 22S, Sipernat® 2200, Sipernat® 25, Sipernat® 33, Sipernat® 50, Sipernat® 50S, Sipernat® 500LS, Sipernat® 101M, Sipernat® 120, Sipernat® 160, Sipernat® 186, Sipernat® 218, Sipernat® 266, Sipernat® 268, Sipernat® 288, Sipernat® 298, Sipernat® 303, Sipernat® 306, Sipernat® 310, Sipernat® 320, Sipernat® 320 DS, Sipernat® 32s AP, Sipernat® 32s C, Sipernat® 340, Sipernat® 350, Sipernat® 360, Sipernat® 622 S, Sipernat® 622 LS, Sipernat® 62s, Sipernat® 680, Sipernat® BG-2, Sipernat® FPS-5, Sipernat® FPS-1, Sipernat® 11 PC, Sipernat® 22 PC, Sipernat® 2200 PC, Sipernat® 44 MS, Sipernat® 820A, Sipernat® 880, Sipernat® D 10, Sipernat® D 13, Sipernat® D 17 from Evonik Industries, Ibersil® D 100, Ibersil® D100P or Ibersil® D 250 from the IGE Group, Flo-Gard SC-72, Flo-Gard LPC from PPG. The precipitated silica of the inventive formulation is suitably characterized by a high liquid absorption capacity, determined as DOA absorption number of at least 120 ml/100 g, preferably at least 140 ml/100 g, mostly preferred at least 160 ml/100 g precipitated silica. DOA is the abbreviation for di-(2-ethylhexyl) adipate (CAS-number 103-23-1). The test method is based on ISO 19246 (“Rubber compounding ingredients-Silica-Oil absorption of precipitated silica”).

Hydrophobic silica is not wettable by water and exhibits an organic surface modification created by chemical reactions with reactive alkylsilanes. The existence of such a surface modification can be proven by various analytical methods, e.g. the carbon content in an elemental analyzer following ISO 3262-19. In an embodiment the precipitated silica or one of the precipitated silica used in the formulations has a hydrophobic surface.

The hydrophobic precipitated silica for the inventive formulation is suitably characterized by a particle size d50 determined by laser diffraction (laser diffraction based on ISO 13320) of at least 4 2 to 50 μm, preferably at least 4 to 25 μm, mostly preferred at least 5 to 15 μm.

In an embodiment the hydrophobic silica is Sipernat® D17 (d50˜10 micron) or Sipernat® D 13 (particle size −d50˜10.5 micron) or Sipernat® D10 (particle size −d50˜6.5 micron, free flowable) or Sipernat® 44 MS (particle size −d50˜3 micron) or Sipernat® 820 A (particle size −d50˜7 micron) or Sipernat® 880 (particle size −d50˜8.5 micron) or combinations thereof.

As used herein, the term “clay” refers to both natural clays as well as modified clays. Modified clays in this context refers to natural clays which have been alkaline-activated or acid-activated. As used herein, the terms “clay minerals” or “special clay minerals” refer to natural clays.

In an embodiment the clay used in the present composition is selected from the group consisting of natural clays comprising bentonite, montmorillonite, beidellite, saponite, hectorite, stevensite, kerolite-saponite, kerolite, talc, pyrophyllite, attapulgite, sepiolite; a mixture of natural silica with a bentonite; any modified clays; and any mixtures thereof.

In an embodiment, the clay is bentonite.

In another embodiment, the antistatic agent used is 10-60%, preferably 25-55% and most preferably 30-50% based on the total weight of the composition.

In yet another embodiment, the silica is used in the amount of 15% to 90%, preferably 25% to 85%, most preferably 35% to 75% based on the total weight of the encapsulated antistatic agent composition.

In another embodiment, the clay is used in the amount of 50% to 90%, preferably 60% to 90%, most preferably 75% to 85% based on the total weight of the encapsulated antistatic agent composition.

In an embodiment, the carrier has a concentration of silica to clay ratio of 1:10 to 10:1, preferably 1:5 to 5:1 and most preferably 1:3 to 3:1.

The clay consisting of a smectite like a bentonite, beidellite, saponite, hectorite, stevensite, kerolite-saponite, is employed in the natural Ca-form or in a soda activated form.

In another embodiment, natural sodium bentonite is used as clay. Especially preferred clays are montmorillonites in the natural or soda activated form or mixtures thereof.

In an embodiment, the clay used is bentonite having cation exchange capacity in the range of 10 meq/100 g to 140 meq/100 g.

In an embodiment, the clay used is bentonite having cation exchange capacity in the range of 20 meq/100 g to 130 meq/100 g, preferably between 30 meq/100 g to 120 meq/100 g.

In another embodiment, the present invention provides method for the preparation of masterbatch of the encapsulated antistatic agent and resin composition wherein the encapsulated antistatic agent are expediently provided in the form of a masterbatch, in which the polymer is preferably polyolefins in which the respective encapsulated antistatic is to be incorporated.

In a preferred embodiment, polymers include polyolefins and polyolefin copolymers selected from the group consisting of polyethylene (PE), preferably selected from the group consisting of high density polyethylene (HDPE), medium density polyethylene (MDPE), low density polyethylene (LDPE), linear low density polyethylene (LLDPE), metallocene low density polyethylene (mLDPE) and metallocene linear low density polyethylene (mLLDPE), polypropylene (PP), preferably selected from the group consisting of polypropylene homopolymer (PPH), polypropylene random copolymer (PP-R) and polypropylene block copolymers (PP-block-COPO), PE copolymers, preferably selected from the group consisting of ethylene-vinyl acetate copolymers (EVA), copolymers of ethylene and methyl acrylate (EMA), copolymers of ethylene and butyl acrylate (EBA), copolymers of ethylene and ethyl acrylate (EEA), and cycloolefin copolymers (COC), general purpose polystyrene (GPPS) and high impact polystyrene (HIPS).

Masterbatches can be prepared by customary physical mixing processes.

A mixing apparatus for the use of a solid masterbatches MB can be a mixer, extruder, kneader, press, mill, calender, blender, injection moulding machine, injection and stretch blow moulding machine (ISBM), extrusion blow moulding machine (EBM), compression moulding machine, compression and stretch blow moulding machine; more preferably a mixer, extruder, injection moulding machine, injection and stretch blow moulding machine, compression moulding machine, compression and stretch blow moulding machine; even more preferably a mixer, extruder, injection and stretch blow moulding machine and extrusion blow moulding machine.

Extruders may be equipped with a metering system for introducing said additives and/or masterbatches into the main stream polymer. This metering may be carried out directly with one or more pure components or with one or more masterbatches.

The type of metering equipment used depends on the form in which the pure component or the masterbatch is metered.

In the case of solid component, a metering device of the feed screw type is usually employed and the point of introduction may be the main inlet of the extruder jointly with the feed of the main polymer granules, or in an unpressurized injection zone located along the extruder. For a solid masterbatch, the metering device may be a system comprising an additional extruder that pre-melts the masterbatch, pressurizes it and meters it by means of a metering pump, the amount of masterbatch metered being fed at a point along the main extruder advantageously without pressure.

In an embodiment, the encapsulated antistatic agent composition can be in the powder form or in granular form.

The anti-static effect of glycerol ester is not permanent. It is well understood that anti-static agent migrates to surface and sometimes gets volatile during processing. As a result, effect is temporary. Therefore, it is necessary and essential to form protective shielding as this would safeguard the active. The unique way of preparing encapsulated antistatic formulation aids to long lasting effect. The release of the antistatic can be modified using a combination of inorganic absorbents so that there is controlled release of active to the surface which is available for longer time.

Patent CN 104250403 discloses the usage of a release agent and antiblocking agent in parts 0.1-1 and the highest loading of antistatic is only 35%. The present invention provides the advantage of using silica and clay mixture as an absorbent. Higher loading percentage of antistatic agent is possible (40-60%) when silica is only used. However, the antistatic agent entrapped into the matrix and the release of antistatic agent to the surface is faster when silica is used as a carrier. The antistatic agent is immobilized as film or liquid or droplets of liquid. In addition, silica is macroporous and release from the carrier into the polymer will depend on the mobility of the active ingredient in the polymer and the interaction of active ingredient with the carrier. Surprisingly it has been found that silica in combination with another inorganic material like clay has the advantage of releasing the active in a controllable manner due to the intercalation and adsorption properties of the clay. Clay acts as carriers for liquids by absorbing them into pores and in between the sheets. Surprisingly this provides a delayed release of active.

The present invention provides antistatic absorbed on silica and clay composition wherein the antistatic are well-incorporated onto porous, hydrophilic mixture of silica and clay. The procedure of melting the antistatics at desired temperature is being practiced with the condition of silica and clay mixture mentioned at same temperature, enhances penetration of active into porous walls of silica and clay mixture. The concentration of antistatic is preferably 10% to 60%, preferably 25% to 55%, most preferably 30% to 50%.

The present invention also provides an encapsulation composition where in the absorbent could be a combination of silica and clay varying from percentage 40 to 90%, preferably 45 to 75%, most preferably 50 to 70% or a clay varying from 50 to 90%, preferably 60 to 90% and most preferably 75 to 85%.

The present invention also provides the advantage of creating a non-existing product category which links the performance of temporary antistatic and permanent antistatic. The temporary antistatic performance exists up to one year and the permanent antistatic last for more than seven years which makes them expensive. The creation of new product range would link the performance between the temporary and permanent antistatic effect.

The use of examples anywhere in this specification including examples of any terms discussed herein is illustrative only, and in no way limits the scope and meaning of the invention or of any exemplified term. Likewise, the invention is not limited to various embodiments given in this specification.

### EXAMPLES

The following examples are given by way of illustration only and therefore, should not be construed to limit the scope of the present invention.

### Preparation Example-1

The substances indicated below are used to prepare the encapsulated antistatic agent enclosing Grinsted PGE 308 as active

| | Silica—Sipernat | Silica—Sipernat | Grinsted PGE |
|---|---|---|---|
| Sample | 22S (wt %) | 22 (wt %) | 308 (wt %) |
| 1a | 60 | | 40 |
| 1b | 50 | | 50 |
| 1c | 40 | | 60 |
| 1d | | 60 | 40 |
| 1e | | 50 | 50 |
| 1f | | 40 | 60 |

For the preparation of encapsulated antistatic agent, silica was first introduced first and the temperature is set above the melting point of Grinsted PGE 308. Slow addition of Grinsted PGE 308 to silica allows the antistatic agent to absorb on the silica which leads to the formation of encapsulated antistatic agent.

### Preparation Example-2

The substances indicated below are used to prepare the encapsulated antistatic agent enclosing Atmer 129 or Grinsted PGE 308 as active.

| | Silica—Sipernat | Clay—Laundrosil | Atmer 129 | Grinsted PGE |
|---|---|---|---|---|
| Sample | 22S (wt %) | DGA (wt %) | (wt %) | 308 (wt %) |
| 2a | 45 | 15 | 40 | — |
| 2b | 45 | 15 | — | 40 |
| 2c | 30 | 30 | 40 | — |
| 2d | 30 | 30 | — | 40 |
| 2e | 15 | 45 | 40 | — |
| 2f | 15 | 45 | — | 40 |

The employed clay powder Laundrosil DGA exhibits a cation exchange capacity determined by the Ammonium chloride method of 75 meq/100 g (method as described in EP2040562B1) For the preparation of encapsulated antistatic agent, silica and clay was first introduced first and the temperature is set above the melting point of antistatic agent. Slow addition of antistatic to silica and clay allows the antistatic agent to absorb on the silica and clay mixture which leads to the formation of encapsulated antistatic agent.

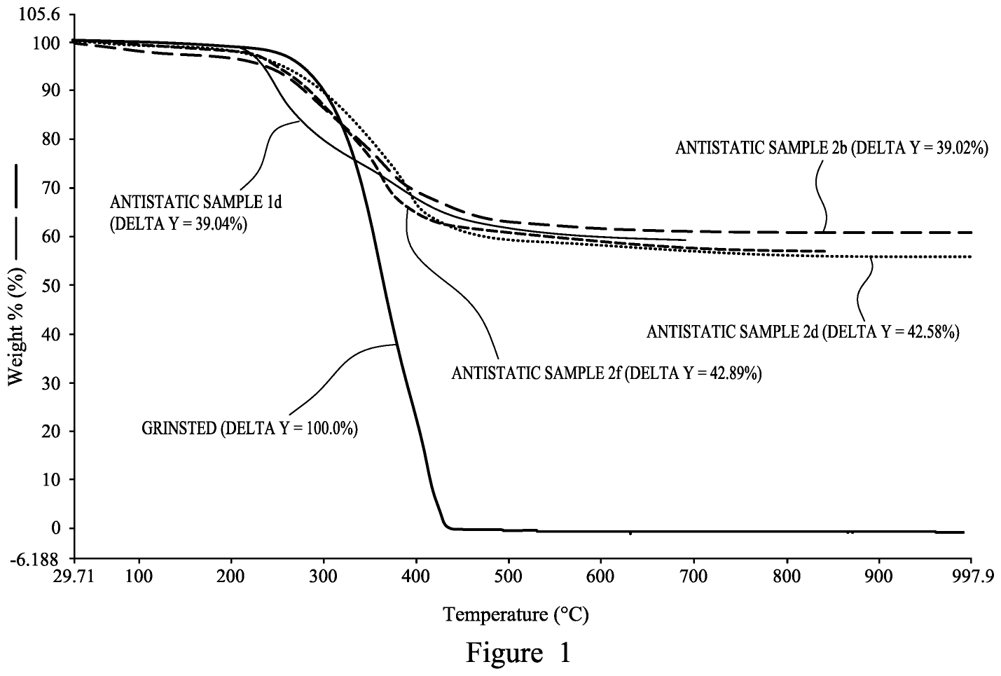

The TGA results in FIG. 1 indicate that Grinsted PGE 308 starts to degrade at 210° C. and loss of active in percentage at 350° C. is 36.24%, whereas it is observed that there is improvement in thermal stability of Grinsted PGE 308 when it is encapsulated using Sipernat 22 (1d) and the loss of active in percentage was found to be 26.21%. Surprisingly there is even more improved in thermal stability of Grinsted PGE 308 when it is encapsulated using Silica and Clay mixture (2b, 2d and 2f), compared to Grinsted PGE 308 encapsulated with silica alone. The loss of active in percentage was found to be 22.76%, 20.175% and 23.92% for 2b, 2d and 2f respectively.

### Preparation Example-3

The substances indicated below are used to prepare encapsulated antistatic agent enclosing Atmer 129 or Grinsted PGE 308 as active

| | Clay—Laundrosil | Atmer 129 | Grinsted PGE |
|---|---|---|---|
| Sample | DGA (wt %) | (wt %) | 308 (wt %) |
| 3a | 85 | 15 | — |
| 3b | 85 | — | 15 |

For the preparation of encapsulated antistatic agent clay was first introduced and the temperature was set above the melting point of antistatic agent and slow addition of antistatic allows them to absorb on the clay which leads to the formation of encapsulated antistatic agent.

### Preparation Example-4

The substances indicated below are used to prepare the encapsulated antistatic agent enclosing Atmer 129 or Grinsted PGE 308 as active

| | Silica—Sipernat | Atmer 129 | Grinsted PGE |
|---|---|---|---|
| Sample | D 10 (%) | (%) | 308 (%) |
| 4a | 60 | 40 | |
| 4b | 60 | | 40 |
| 4c | 70 | 30 | |
| 4d | 70 | | 30 |

For the preparation of encapsulated antistatic agent, Sipernat D 10 was first introduced and the temperature was set above the melting point of antistatic agent. Slow addition of antistatic agent allowed them to absorb on Sipernat D 10 which lead to the formation of encapsulated antistatic agent.

1. An encapsulated antistatic agent composition comprising:
a) carrier consisting of a mixture of silica and clay; and
b) at least one antistatic agent encapsulated in the carrier
wherein the concentration of carrier is in the range of 40 to 90% and said antistatic agent in the range of 10 to 60% based on the total weight of the composition.

2. The composition as claimed in claim 1, wherein said antistatic agent is a glycerol ester.

3. The composition as claimed in claim 2, wherein said glycerol ester is glycerol monostearate.

4. The composition as claimed in claim 1, wherein said antistatic agent is a mixture of stearic acid, palmitic acid monoester with triglycerol or a blend of stearic acid, monoester with triglycerol and 2,3-dihydroxypropyl laurate.

5. The composition as claimed in claim 1, wherein the carrier has a concentration of clay as 50 to 90% based on the total weight of the composition.

6. The composition as claimed in claim 1, wherein the carrier has a ratio of silica to clay from 1:10 to 10:1.

7. The composition as claimed in claim 1, wherein said clay is selected from the group consisting of natural clays comprising bentonite, montmorillonite, beidellite, saponite, hectorite, stevensite, kerolite-saponite, kerolite, talc, pyrophyllite, attapulgite, sepiolite; a mixture of natural silica with a bentonite; any modified clays; and any mixtures thereof.

8. The composition as claimed in claim 1, wherein the clay contains a natural or sodium activated bentonite or a mixture containing both.

9. The composition as claimed in claim 1, wherein said clay contains a natural or sodium activated bentonite with a cation exchange capacity in the range of 10 meq/100 g to 140 meq/100 g.

10. The composition as claimed in claim 1, wherein the silica is a precipitated silica.

11. The composition as claimed in claim 10, wherein the precipitated silica is a hydrophilic precipitated silica or a hydrophobic precipitated silica or a mixture of both.

12. The composition as claimed in claim 11, wherein the hydrophilic silica has a liquid carrying capacity determined as DOA absorption number of at least 120 ml/100 g precipitated silica.

13. The composition as claimed in claim 11, wherein the hydrophilic silica has a particle size d50 determined by laser diffraction of 4 to 300 μm.

14. The composition as claimed in claim 11, wherein the hydrophobic silica has a particle size d50 determined by laser diffraction of 2 to 50 μm, preferably at 4 to 25 μm.

15. The composition as claimed in claim 1, wherein said silica is used in the amount of 15% to 90% based on the total weight of the composition.

16. A method for preparing a masterbatch of encapsulated antistatic agent composition of claim 1, wherein the encapsulated antistatic agent are expediently provided in the form of a masterbatch, in which the polymer includes a polyolefin in which the respective encapsulated antistatic is to be incorporated.

17. The composition as claimed in claim 16, as a masterbatch.

18. The composition as claimed in claim 16, as a masterbatch for polymers.

19. The masterbatch as claimed in claim 16, including encapsulated antistatic agent composition wherein said encapsulated antistatic agent is retained at a heating cycle of a temperature in range of 100° C.-250° C. during processing of an article.
